(19) United States
(12) Patent Application Publication
(10) Pub. No.: US 2021/0406691 A1
(43) Pub. Date: Dec. 30, 2021

(54) METHOD AND APPARATUS FOR MULTI-RATE NEURAL IMAGE COMPRESSION WITH MICRO-STRUCTURED MASKS

(71) Applicant: TENCENT AMERICA LLC, Palo Alto, CA (US)

(72) Inventors: Wei JIANG, Sunnyvale, CA (US); Wei WANG, San Jose, CA (US); Shan LIU, San Jose, CA (US)

(73) Assignee: TENCENT AMERICA LLC, Palo Alto, CA (US)

(21) Appl. No.: 17/242,874

(22) Filed: Apr. 28, 2021

Related U.S. Application Data
(60) Provisional application No. 63/087,519, filed on Oct. 5, 2020.
(60) Provisional application No. 63/045,341, filed on Jun. 29, 2020.

(51) Int. Cl. G06N 3/08; G06N 3/04

(52) U.S. Cl. CPC G06N 3/082; G06F 8/36; G06N 3/0454

(57) ABSTRACT

A method of multi-rate neural image compression includes selecting encoding masks, based on a hyperparameter, and performing a convolution of a first plurality of weights of a first neural network and the selected encoding masks to obtain first masked weights. The method further includes encoding an input image to obtain an encoded representation, using the first masked weights, and encoding the obtained encoded representation to obtain a compressed representation.

### CROSS-REFERENCE TO RELATED APPLICATIONS

This application is based on and claims priority to U.S. Provisional Patent Application No. 63/045,341, filed on Jun. 29, 2020, and U.S. Provisional Patent Application No. 63/087,519, filed on Oct. 5, 2020, the disclosures of which are incorporated by reference herein in their entireties.

### BACKGROUND

Standard groups and companies have been actively searching for potential needs for standardization of future video coding technology. These standard groups and companies have focused on artificial intelligence (AI)-based end-to-end neural image compression (NIC) using deep neural networks (DNNs). The success of this approach has brought more and more industrial interest in advanced neural image and video compression methodologies.

Flexible bitrate control remains a challenging issue for previous NIC methods. Conventionally, it may include training multiple model instances targeting each desired trade-off between a rate and a distortion (a quality of compressed images) individually. All these multiple model instances may need to be stored and deployed on a decoder side to reconstruct images from different bitrates. This may be prohibitively expensive for many applications with limited storage and computing resources.

### SUMMARY

According to embodiments, a method of multi-rate neural image compression is performed by at least one processor and includes selecting encoding masks, based on a hyperparameter, and performing a convolution of a first plurality of weights of a first neural network and the selected encoding masks to obtain first masked weights. The method further includes encoding an input image to obtain an encoded representation, using the first masked weights, and encoding the obtained encoded representation to obtain a compressed representation.

According to embodiments, an apparatus for multi-rate neural image compression includes at least one memory configured to store program code, and at least one processor configured to read the program code and operate as instructed by the program code. The program code includes first selecting code configured to cause the at least one processor to select encoding masks, based on a hyperparameter, and first performing code configured to cause the at least one processor to perform a convolution of a first plurality of weights of a first neural network and the selected encoding masks to obtain first masked weights. The program code further includes first encoding code configured to cause the at least one processor to encode an input image to obtain an encoded representation, using the first masked weights, and second encoding code configured to cause the at least one processor to encode the obtained encoded representation to obtain a compressed representation.

According to embodiments, a non-transitory computer-readable medium stores instructions that, when executed by at least one processor for multi-rate neural image compression, cause the at least one processor to select encoding masks, based on a hyperparameter, and perform a convolution of a first plurality of weights of a first neural network and the selected encoding masks to obtain first masked weights. The instructions, when executed by the at least one processor, further cause the at least one processor to encode an input image to obtain an encoded representation, using the first masked weights, and encode the obtained encoded representation to obtain a compressed representation.

### BRIEF DESCRIPTION OF THE DRAWINGS

FIG. 1 is a diagram of an environment in which methods, apparatuses and systems described herein may be implemented, according to embodiments.

FIG. 2 is a block diagram of example components of one or more devices of FIG. 1.

FIG. 3 is a block diagram of a test apparatus for multi-rate neural image compression, during a test stage, according to embodiments.

FIG. 4A is a block diagram of a training apparatus for multi-rate neural image compression, during a training stage, according to embodiments.

FIG. 4B is a block diagram of a training apparatus for multi-rate neural image compression, during a training stage, according to embodiments.

FIG. 4C is a block diagram of a training apparatus for multi-rate neural image compression, during a training stage, according to embodiments.

FIG. 5 is a flowchart of a method of multi-rate neural image compression, according to embodiments.

FIG. 6 is a block diagram of an apparatus for multi-rate neural image compression, according to embodiments.

FIG. 7 is a flowchart of a method of multi-rate neural image decompression, according to embodiments.

FIG. 8 is a block diagram of an apparatus for multi-rate neural image decompression, according to embodiments.

### DETAILED DESCRIPTION

The disclosure describes a method and an apparatus for compressing an input image, using a multi-rate NIC framework in which only one NIC model instance is used to achieve image compression at multiple bitrates with guidance from multiple binary masks targeting different bitrates.

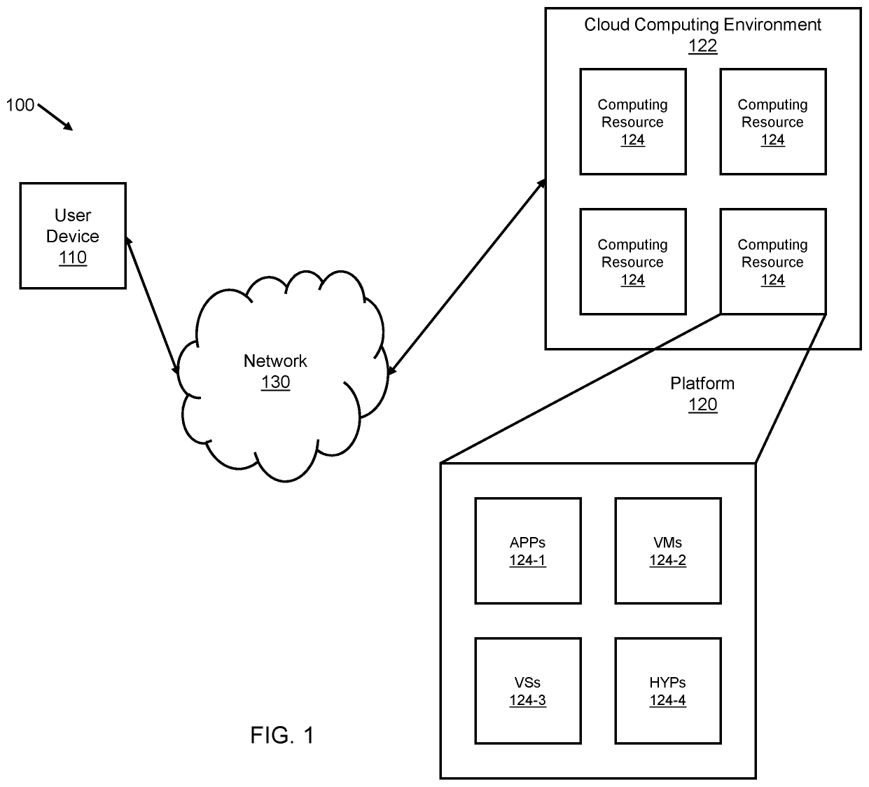

FIG. 1 is a diagram of an environment 100 in which methods, apparatuses and systems described herein may be implemented, according to embodiments.

As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g., the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (“APPs”) 124-1, one or more virtual machines (“VMs”) 124-2, virtualized storage (“VSs”) 124-3, one or more hypervisors (“HYPs”) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g., a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (“OS”). A process virtual machine may execute a single program, and may support a single process. In some implementations, the virtual machine 124-2 may execute on behalf of a user (e.g., the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g., “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment 100 may perform one or more functions described as being performed by another set of devices of the environment 100.

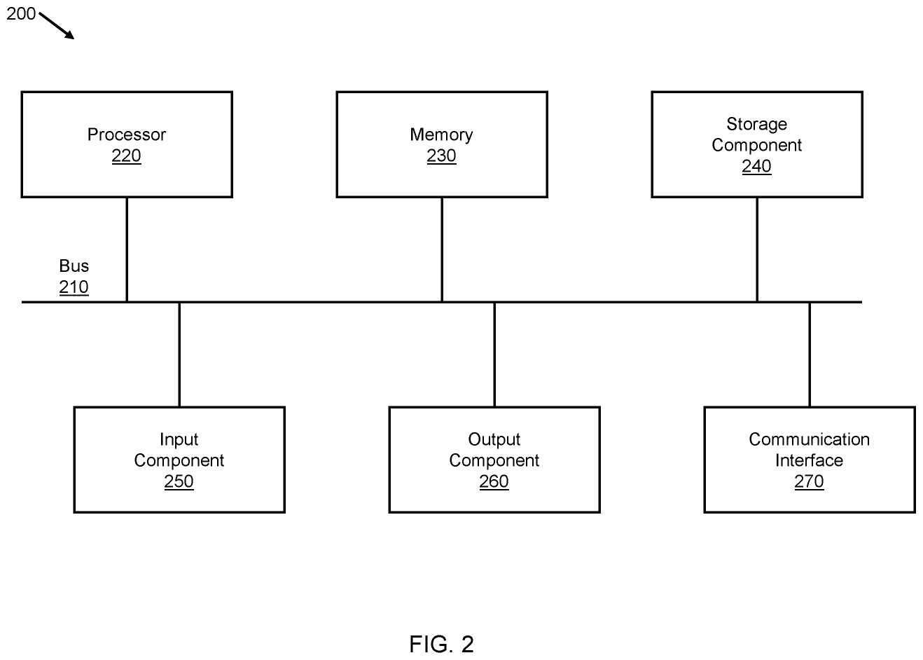

FIG. 2 is a block diagram of example components of one or more devices of FIG. 1.

A device 200 may correspond to the user device 110 and/or the platform 120. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g., a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g., a touch screen display, a keyboard, a keypad, a mouse, a button, a switch, and/or a microphone). Additionally, or alternatively, the input component 250 may include a sensor for sensing information (e.g., a global positioning system (GPS) component, an accelerometer, a gyroscope, and/or an actuator). The output component 260 includes a component that provides output information from the device 200 (e.g., a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

A method and an apparatus for multi-rate neural image compression will now be described in detail.

This disclosure proposes a multi-rate NIC framework for learning and deploying only one NIC model instance that supports multi-rate image compression. A set of binary masks is learned, one for each targeted bitrate, to guide a decoder in a reconstruction stage to recover images from different bitrates.

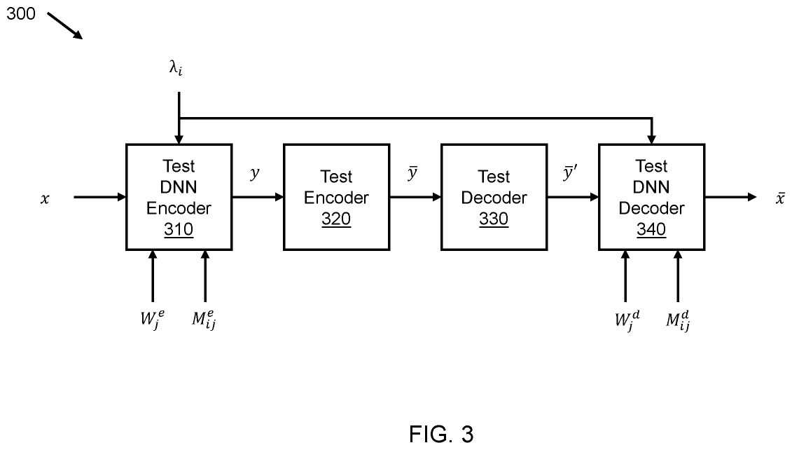

FIG. 3 is a block diagram of a test apparatus 300 for multi-rate neural image compression, during a test stage, according to embodiments.

Referring to FIG. 3, the test apparatus 300 includes a test DNN encoder 310, a test encoder 320, a test decoder 330 and a test DNN decoder 340.

Given an input image x of size (h,w,c), where h, w, c are the height, width, and a number of channels, respectively, a target of the test stage of an NIC workflow can be described as follows.

The test DNN encoder 310 encodes the input image x to obtain an encoded representation y, using a DNN.

The test encoder 320 encodes the obtained encoded representation y to obtain a compressed representation y̅ that is compact for storage and transmission. The obtained encoded representation y may encoded through quantization and entropy encoding.

The test decoder 330 decodes the obtained compressed representation y̅ to obtain a recovered representation y̅′. The obtained compressed representation y̅ may be decoded through decoding and dequantization.

The test DNN decoder 340 decodes the obtained recovered representation y̅′ to reconstruct a reconstructed image x̅, using a DNN. The reconstructed image x̅′ should be similar to the original input image x.

There is not any restriction on network structures of the test DNN encoder 310 and the test DNN decoder 340. Also, there is not any restriction on methods (quantization and entropy coding) that are used by the test encoder 320 and the test decoder 330.

To learn an NIC model, there may be a need to balance two competing desires: better reconstruction quality versus less bit consumption. A loss function D (x, x̅) is used to measure a reconstruction error, which is called a distortion loss, such as peak signal-to-noise ratio (PSNR) and/or structural similarity index measure (SSIM). A rate loss R(y̅) is computed to measure a bit consumption of the compressed representation y. Therefore, a trade-off hyperparameter λ is used to optimize a joint rate-distortion (R-D) loss:

L(x,x̅,y̅)=D(x, x̅)+λR(y̅) (1)

Training with a large hyperparameter λ results in compression models with smaller distortion but more bit consumption, and vice versa. Traditionally, for each value of a predefined hyperparameter λ, an NIC model instance will be trained, which will not work well for other values of the predefined hyperparameter λ. Therefore, to achieve multiple bitrates of a compressed stream, traditional methods may require training and storing multiple model instances.

In embodiments, a method and an apparatus for multi-rate neural image compression use one single trained model instance of an NIC network, and use a set of binary masks to guide the NIC model instance to generate different compressed representations as well as a corresponding reconstructed image, each mask targeting a different value of a hyperparameter λ.

In detail, {Wⱼ^{e}} and {Wⱼ^{d}} denote a set of weight coefficients of an encoder and a decoder part of the NIC model instance, respectively, where {Wⱼ^{e}} and {Wⱼ^{d}} are the weight coefficients of a j-th layer of the test DNN encoder 310 and the test DNN decoder 340, respectively. λ₁, . . . , λ_{N} denote N hyperparameters, and y̅ᵢ and x̅ᵢ denote a compressed representation and a reconstructed image that correspond to a hyperparameter λᵢ. Mᵢⱼ^{e} and Mᵢⱼ^{d} denote binary masks for the j-th layer of the test DNN encoder 310 and the test DNN decoder 340, respectively, corresponding to the hyperparameter λᵢ. Weights Wⱼ^{e} is a 5-dimensional (5D) tensor with size (c₁, k₁, k₂, k₃, c₂). An input of a layer is a 4-dimensional (4D) tensor A of size (h₁,w₁,d₁,c₁), and an output of the layer is a 4D tensor B of size (h₂,w₂,d₂,c₂). The sizes c₁, k₁, k₂, k₃, c₂, h₁, w₁, d₁, h₂, w₂, d₂ are integer numbers greater or equal to 1. When any of the sizes c₁, k₁, k₂, k₃, c₂, h₁, w₁, d₁, h₂, w₂, d₂ is the number 1, the corresponding tensor reduces to a lower dimension. Each item in each tensor is a floating number. The parameters h₁, w₁ and d₁ (h₂, w₂ and d₂) are height, weight and depth of the input tensor A (output tensor B). The parameter c₁ (c₂) is a number of input (output) channels. The parameters k₁, k₂ and k₃ are sizes of convolution kernels corresponding to height, weight and depth axes, respectively. The output tensor B is computed through a convolution operation Θ, based on the input tensor A, the masks Mᵢⱼ^{e} and the weights Wⱼ^{e}. That is, the output tensor B is computed as the input tensor A convolving with masked weights Wᵢⱼ^{e}′=Wⱼ^{e}·Mᵢⱼ^{e}, where is element-wise multiplication. Similarly, for the weights Wⱼ^{d}, their output tensor B is computed through a convolution operation of the input tensor A with masked weights Wᵢⱼ^{d}′=Wⱼ^{d}·Mᵢⱼ^{d}.

Referring to FIG. 3, the test DNN encoder 310 includes only one model instance with the weights {Wⱼ^{e}}, and the test DNN decoder 340 includes only one model instance with the weights {Wⱼ^{d}}. Given the input image x, and given the target hyperparameter the test DNN encoder 310 selects the set of the encoding masks {Mᵢⱼ^{e}} to compute the masked weights {Wᵢⱼ^{e}′}, which are used by the test DNN encoder 310 to compute the DNN-encoded representation y. Then, the test encoder 320 computes the compressed representation y̅ in an encoding process. Based on the compressed representation y̅, the test decoder 330 computes the recovered representation y̅′ through a decoding process. Using the hyperparameter λᵢ, the test DNN decoder 340 selects the set of the decoding masks {Mᵢⱼ^{d}} to compute the masked weights {Wᵢⱼ^{d}′}, which are used by the test DNN decoder 340 to compute the reconstructed image x̅, based on the recovered representation y̅′.

A shape of the weight Wⱼ^{e} or Wⱼ^{d} (so as the mask Mᵢⱼ^{e} or Mᵢⱼ^{d}) can be changed to correspond to a convolution of a reshaped input with the reshaped weight Wⱼ^{e} or Wⱼ^{d} to obtain the same output. In detail, there may be two configurations. First, the 5D weight tensor may be reshaped into a 3D tensor of size (C′₁, C′₂, k), where c′₁×c′₂×k=c₁×c₂×k₁×k₂×k₃. For example, a configuration may be c′₁=c₁, c′₂=c₂, k=k₁×k₂×k₃. Second, the 5D weight tensor may be reshaped into a 2D matrix of size (c′₁, c′₂), where c′₁×c′₂=c₁×c₂×k₁×k₂×k₃. For example, configurations may be c′₁=c₁, c′₂=c₂×k₁×k₂×k₃, or c′₂=c₂ , c′₁=c₁×k₁×k₂×k₃.

A desired micro-structure of the masks may be designed to align with an underlying GEMM matrix multiplication process of how the convolution operation is implemented so that an inference computation of using the masked weight coefficients can be accelerated. In an example, block-wise micro-structures may be used for the masks (so as the masked weight coefficients) of each layer in the 3D reshaped weight tensor or the 2D reshaped weight matrix. For the case of the reshaped 3D weight tensor, a mask may be partitioned into blocks of size (gᵢ, gₒ, gₖ), and for the case of reshaped 2D weight matrix, a mask may be partitioned into blocks of size (gᵢ,gₒ). All items in a block of a mask will have the same binary value 1 or 0. That is, weight coefficients are masked out in a block-wise micro-structured fashion.

A goal is to learn a set of micro-structured encoding masks {Mᵢⱼ^{e}} and micro-structured decoding masks {Mᵢⱼ^{d}}, each of the masks Mᵢⱼ^{e} and Mᵢⱼ^{d} targeting each of hyperparameters λᵢ. A progressive multi-stage training framework may achieve this goal.

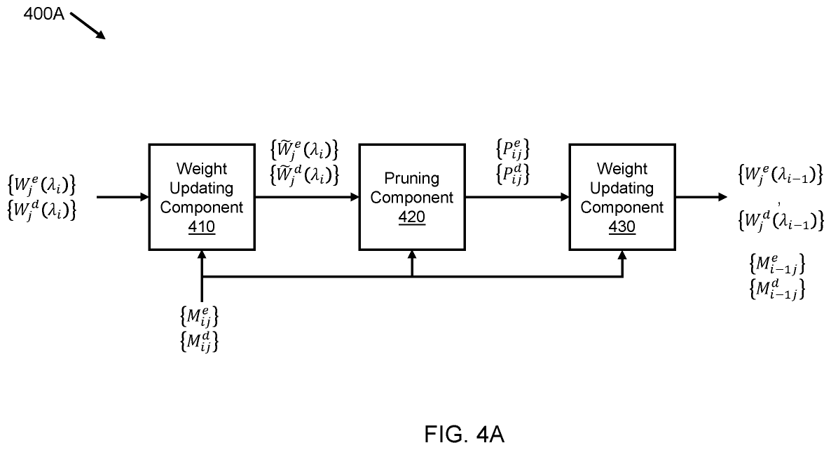

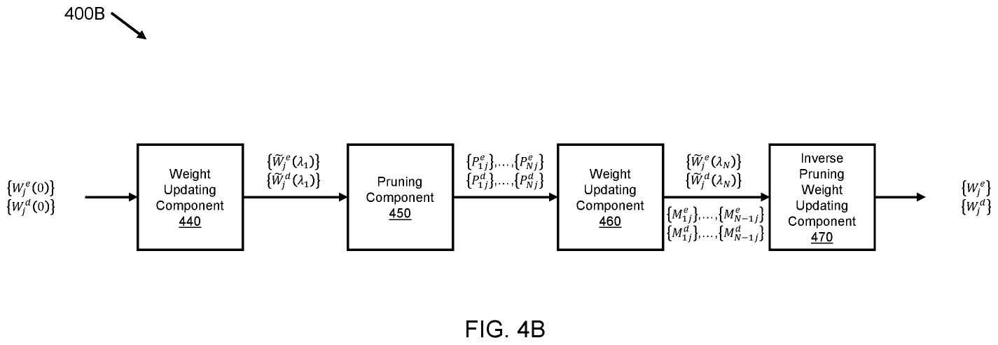

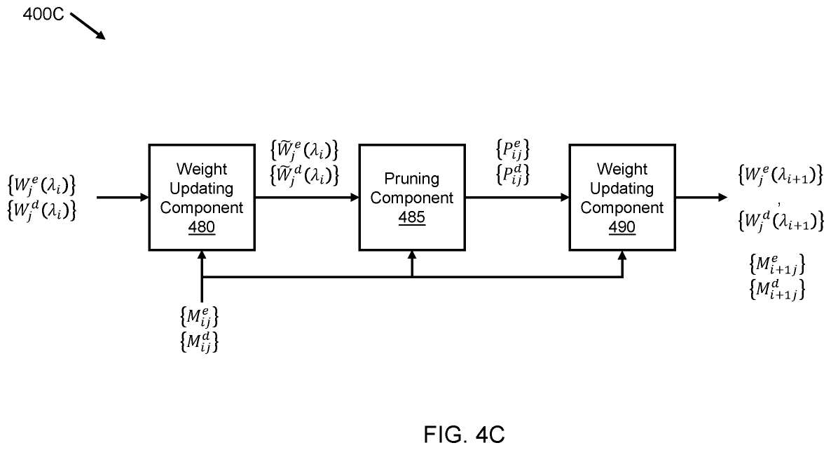

In detail, assume that the hyperparameters λ₁, . . . , λᵢ are ranked in ascending order, and correspond to masks that generate compressed representations with increasing distortion (decreasing quality) and decreasing rate loss (increasing bitrates). Two different training frameworks may be used to learn a model instance and the masks, i.e., {Wⱼ^{e}},{Wⱼ^{d}},{Mⱼ^{e}},{Mᵢⱼ^{d}}, as illustrated in FIG. 4A.

An overall workflow of the first training framework is shown in FIG. 4A.

FIG. 4A is a block diagram of a training apparatus 400A for multi-rate neural image compression, during a training stage, according to embodiments.

Referring to FIG. 4A, the training apparatus 400A includes a weight updating component 410, a pruning component 420 and a weight updating component 430.

Assume that a current target is to train the masks targeting a hyperparameter λᵢ₋₁, a current model instance has weights {Wⱼ^{e}(λᵢ)},{Wⱼ^{d}(λᵢ)}, and the masks are denoted {Mᵢⱼ^{e}}, {Mᵢⱼ^{d}}. The goal is to obtain masks {Mᵢ₋₁ⱼ^{e}},{Mᵢ₋₁ⱼ^{d}}, as well as updated weights {Wⱼ^{e}(λᵢ₋₁)},{Wⱼ^{d}(λᵢ₋₁)}.

In a first step, the weight coefficients among the weights {Wⱼ^{e}(λᵢ)},{Wⱼ^{d}(λᵢ)} that are masked by {Mᵢⱼ^{e}}, {Mᵢⱼ^{d}}, respectively, are fixed or set. For example, if an entry in the mask Mᵢⱼ^{e} is 1, the corresponding weight Wⱼ^{e}(λᵢ) is fixed.

Then, the weight updating component 410 updates remaining unmasked weight coefficients among the weights {Wⱼ^{e}(λᵢ)} and {Wᵢ^{d}(λᵢ)} through backpropagation, using an R-D loss of Equation (1) targeting at a first hyperparameter λ₁, into updated weights {\tilde{W}ⱼ^{e}(λᵢ)} and {\tilde{W}ⱼ^{d}(λᵢ)}. Multiple epoch iterations may be performed to optimize the R-D loss in this weight update process, e.g., until reaching a maximum iteration number or until a loss converges.

After that, a micro-structured weight pruning process is performed. In this process, using the updated weights {\tilde{W}ⱼ^{e}(λᵢ)} and {\tilde{W}ⱼ^{d}(λᵢ)} as inputs, for the unfixed weight coefficients among the updated weights {\tilde{W}ⱼ^{e}(λᵢ)} and {\tilde{W}ⱼ^{d}(λᵢ)}, the pruning component 420 obtains or computes a pruning loss Lₛ(b) (e.g., the L₁ or L₂ norm of the weights in a block) for each micro-structured block b (3D block for 3D reshaped weight tensor or 2D block for 2D reshaped weight matrix). The pruning component 420 ranks these micro-structured blocks in ascending order, and prunes the blocks (i.e., by setting corresponding weights in the pruned blocks as 0) top down from a ranked list until a stop criterion is reached.

For example, given a validation dataset Sᵥₐₗ, the NIC model with the updated weights {\tilde{W}ⱼ^{e}(λᵢ)}, {\tilde{W}ⱼ^{d}(λᵢ)} and the masks {Mᵢⱼ^{e}},{Mᵢⱼ^{d}} generates a distortion loss Dᵥₐₗ({\tilde{W}ⱼ^{e}(λᵢ)}, {\tilde{W}ⱼ^{d}(λᵢ)}, {Mᵢⱼ^{e}}, {Mᵢⱼ^{d}}). As more and more micro-blocks are pruned, this distortion loss will gradually increase. The stop criterion can be a tolerable percentage threshold that allows the distortion loss to increase.

The pruning component 420 generates a set of binary pruning masks {Pᵢⱼ^{e}} and {Pᵢⱼ^{d}}, where an entry in the mask Pᵢⱼ^{e} or Pᵢⱼ^{d} being 0 means the corresponding weight Wⱼ^{e} or Wⱼ^{d} is pruned.

Then, the weight updating component 430 fixes additional unfixed weights among the updated weights {\tilde{W}ⱼ^{e}(λᵢ)} and {\tilde{W}ⱼ^{d}(λᵢ)} that are masked by the masks {Pᵢⱼ^{e}} and {Pᵢⱼ^{d}}, and updates remaining weights among the updated weights {\tilde{W}ⱼ^{e}(λᵢ)} and {\tilde{W}ⱼ^{d}(λᵢ)} that are not masked by either the masks {Pᵢⱼ^{e}},{Pᵢⱼ^{d}} or {Mᵢⱼ^{e}}, {Mᵢⱼ^{d}}, by regular backpropagation to optimize the overall R-D loss of Equation (1) targeting the hyperparameter λᵢ₋₁. Multiple epoch iterations may be performed to optimize the R-D loss in this weight update process, e.g., until reaching a maximum iteration number or until the loss converges. Then, the weight updating component 430 obtains or computes corresponding masks {Mᵢ₋₁^{e}} and {Mᵢ₋₁^{d}} as: Mᵢ₋₁ⱼ^{e}=Mᵢⱼ^{e}∪Pᵢⱼ^{e} and Mᵢ₋₁ⱼ^{d}=Mᵢⱼ^{d}∪Pᵢⱼ^{d}. That is, non-pruned entries among the masks Pᵢⱼ^{e}(Pᵢⱼ^{d}) that are non-masked in the masks Mᵢⱼ^{e}(Mᵢⱼ^{d}) will be additionally set to 1 as being masked in Mᵢ₋₁ⱼ^{e}(Mᵢ₋₁ⱼ^{d}. Also, the weight updating component 430 outputs the updated weights {Wⱼ^{e}(λᵢ₋₁)} and {Wⱼ^{d}(λᵢ₋₁)}. The final updated weights {Wⱼ^{e}(λᵢ)} and {Wⱼ^{d}(λ₁)} are the final output weights {Wⱼ^{e}} and {Wⱼ^{d}} for the learned model instance.

An overall workflow of the second training framework is shown in FIG. 4B.

FIG. 4B is a block diagram of a training apparatus 400B for multi-rate neural image compression, during a training stage, according to embodiments.

Referring to FIG. 4B, the training apparatus 400B includes a weight updating component 440, a pruning component 450, a weight updating component 460, and an inverse pruning weight updating component 470.

Given a set of initial weights {Wⱼ^{e}(0)} and {Wⱼ^{d}(0)} (e.g., randomly initialized according to some distributions), the weight updating component 440 learns a set of model weights {\tilde{W}ⱼ^{e}(λᵢ)}, {\tilde{W}ⱼ^{d}(λ₁)} through a weight update process using regular backpropagation using a training dataset Sₜᵣ, by optimizing the R-D loss of Equation (1) targeting a hyperparameter λ₁.

After that, the pruning component 450 performs a micro-structured pruning process based on the model weights {\tilde{W}ⱼ^{e}(λᵢ)}, {\tilde{W}ⱼ^{d}(λᵢ)}. In this micro-structured pruning process, the pruning component 450 partitions each reshaped 3D weight tensor or 2D weight matrix into micro-blocks (3D blocks for a 3D reshaped weight tensor or 2D blocks for a 2D reshaped weight matrix), and obtains or computes a pruning loss Lₛ(b) (e.g., an L₁ or L₂ norm of weights in a block) for each micro-structured block b.

The pruning component 450 ranks these micro-structured blocks in ascending order, and prunes the blocks (i.e., by setting the corresponding weights in the pruned blocks as 0) from top to down on a ranked list to target each of the hyperparameters λ₁, . . . , λ_{N} in the following way. Assuming the current weights are {\tilde{W}ⱼ^{e}(λᵢ)}, {\tilde{W}ⱼ^{d}(λᵢ)}, the pruning component 450 obtains corresponding binary pruning masks {Pᵢⱼ^{e}} and {Pᵢⱼ^{d}}, in which an entry in the mask Pᵢⱼ^{e} or Pᵢⱼ^{d} being 0 means the corresponding weight among the weights \tilde{W}ⱼ^{e} (λᵢ) or \tilde{W}ᵢ^{d}(λᵢ) is pruned. The pruning component 450 further obtains the pruning masks {Pᵢ₊₁ⱼ^{e}} and {Pᵢ₊₁ⱼ^{d}} for λᵢ₊₁, to obtain updated weights {\tilde{W}ⱼ^{e}(λᵢ₊₁)}, {\tilde{W}ⱼ^{d}(λᵢ₊₁)}. To achieve this goal, in the pruning process, the pruning component 450 fixes weight coefficients among the weights \tilde{W}ⱼ^{e}(λᵢ) or \tilde{W}ⱼ^{d}(λᵢ) that are masked to be pruned by the masks {Pᵢⱼ^{e}}and{Pᵢⱼ^{d}}, continues to prune down, in the ranked list, remaining unpruned micro-blocks until reaching a stop criterion for the hyperparameter λᵢ₊₁. For example, given a validation dataset Sᵥₐₗ, the NIC model with the weights {\tilde{W}ⱼ^{e}(λᵢ)}, {\tilde{W}ⱼ^{d} (λᵢ)} generates a distortion loss Dᵥₐₗ({\tilde{W}ⱼ^{e}(λᵢ)}, {\tilde{W}ⱼ^{d}(λᵢ)}). As more and more micro-blocks are pruned, this distortion loss will gradually increase. The stop criterion can be a tolerable percentage threshold that we allow the distortion loss to increase. Then, the pruning component 450 generates pruning masks {Pᵢ₊₁ₕ^{e}} and {Pᵢ₊₁ⱼ^{d}} by adding these additional pruned micro-blocks into the masks {P ᵢⱼ^{e}} and {Pᵢⱼ^{d}}.

Then, in a weight update process, the weight updating component 460 fixes all these pruned micro-blocks masked by the masks {Pᵢ₊₁ⱼ^{e}} and {Pᵢ₊₁ⱼ^{d}}, and updates remaining unfixed weights, using regular backpropagation to optimize the R-D loss of Equation (1) targeting the hyperparameter λᵢ₊₁, to generate a set of updated weights {\tilde{W}ᵢ^{e}(λᵢ₊₁)}, {\tilde{W}ⱼ^{d} (λᵢ₊₁)}. By repeating the above pruning and weight update processes for each of the hyperparameters λ₁, . . . , λ_{N}, the pruning component 450 obtains the set of pruning masks {P₁ⱼ^{e}}, . . . , {P_{Nj}^{e}}, {P₁ⱼ^{d}}, . . . , {P_{Nj}^{d}}, and the weight updating component 460 updates final updated weights {\tilde{W}ⱼ^{e}(λ_{N})}, {\tilde{W}ⱼ^{d}(λ_{N})}. The pruning masks {Pᵢⱼ^{e}} and {Pᵢⱼ^{d}} are directly used as the model masks {Mᵢⱼ^{e}} and {Mᵢⱼ^{d}} for the hyperparameter λᵢ.

After that, the inverse pruning weight updating component 470 trains the weights {Wⱼ^{e}} and {Wⱼ^{d}} through an inverse pruning weight update process based on the final updated weights {\tilde{W}ⱼ^{e}(λ_{N})}, {\tilde{W}ⱼ^{d}(λ_{N})} and the model masks {Mrhd 1j^{e}}, . . . , {Mᵢⱼ^{e}} and {M₁ⱼ^{d}}, . . . , {Mᵢⱼ^{d}} in the following way. Assuming the current weights {\tilde{W}ⱼ^{e}(λᵢ)}, {\tilde{W}ⱼ^{d}(λᵢ)} are obtained, and weight coefficients among the weights {\tilde{W}ⱼ^{e}(λᵢ)}, {\tilde{W}ⱼ^{d}(λᵢ)} that are masked as 1 in the masks {Mᵢⱼ^{e}} and {Mᵢⱼ^{d}} are fixed, weight coefficients that are masked as 1 in the masks {Mᵢ₋₁ⱼ^{e}} and {Mᵢ₋₁^{d}} but 0 in the masks {Mᵢⱼ^{e}} and {Mᵢⱼ^{d}} are filled in. These weights can be filled with their original values at a time they are pruned in the pruning process, or they can be filled with randomly initialized values. Then, the inverse pruning weight updating component 470 updates these newly-filled weights with regular backpropagation by optimizing the R-D loss of Equation (1) targeting the hyperparameter λᵢ₋₁. This results in the updated weights {\tilde{W}ⱼ^{e}(λᵢ₋₁)}, {\tilde{W}ⱼ^{d}(λᵢ₋₁)}. This process is repeated until last weights {\tilde{W}ⱼ^{e}(λ₁)}, {\tilde{W}Wⱼ^{d}(λ₁)}. {\tilde{W}ⱼ^{e}(λ₁)}, {\tilde{W}ⱼ^{d}(λ₁)} are obtained as final output {Wⱼ^{e}} and {Wⱼ^{d}}.

In embodiments, a prune-and-grow (PnG) training framework may be used to learn binary masks. FIG. 4C gives an overall workflow of this PnG training framework.

FIG. 4C is a block diagram of a training apparatus 400C for multi-rate neural image compression, during a training stage, according to embodiments.

Referring to FIG. 4C, the training apparatus 400C includes a weight updating component 480, a pruning component 485 and a weight updating component 490.

The goal is to learn the set of sparse encoding masks {Mᵢⱼ^{e}} and sparse decoding masks {Mᵢⱼ^{d}}, each of the masks Mᵢⱼ^{e} and Mᵢⱼ^{d} targeting each hyperparameter λᵢ. The PnG training framework is a progressive multi-stage training framework to achieve this goal.

In detail, assume that hyperparameters λ₁, . . . , λ_{N} are ranked in a descending order, and correspond to masks that generate compressed representations with increasing distortion (decreasing quality) and decreasing rate loss. Assume that a current target is to train the masks targeting a hyperparameter λᵢ₊₁, a current model instance has weights {Wⱼ^{e}(λᵢ)}, {Wⱼ^{d}(λᵢ)}, and the masks are denoted {Mᵢⱼ^{e}}, {Mᵢⱼ^{d}}. The goal is to obtain masks {Mᵢ₊₁ⱼ^{e}}, {Mᵢ₊₁ⱼ^{d}}, as well as updated weights {Wⱼ^{e}(λᵢ₊₁)}, {Wⱼ^{d}(λᵢ₊₁)}.

In a first step, weight coefficients among the weights {Wⱼ^{e}(λᵢ)}, {Wⱼ^{d}(λᵢ)} are masked by the masks {Mᵢⱼ^{e}}, {Mᵢⱼ^{d}}, respectively. For example, if an entry in the mask Mᵢⱼ^{e} is 1, the corresponding weight Wⱼ^{e}(λᵢ) will be fixed.

Then, the weight updating component 480 updates remaining unmasked weight coefficients among the weights {Wⱼ^{e}(λᵢ)} and {Wⱼ^{d}(λᵢ)} through regular backpropagation using R-D loss of Equation (1) targeting hyperparameters λᵢ₊₁, into updated weights {\tilde{W}ⱼ^{e}(λᵢ)} and {\tilde{W}ⱼ^{d}(λᵢ)}. Multiple epoch iterations will be taken to optimize the R-D loss in this weight update process, e.g., until reaching a maximum iteration number or until the loss converges.

After that, the pruning component 485 performs a weight pruning process. Any DNN weight pruning method such as an unstructured weight sparsification method [1] or a structured weight pruning method [2] can be used here. A sparse regularization loss S({Wⱼ^{e}}{Wⱼ^{d}}) may be added to the original R-D loss to obtain a total loss:

L(x, x̅, y̅)=D(x,x̅)±λR(y̅)+ηS({Wⱼ^{e}}{Wⱼ^{d}}) (2)

Hyperparameter η≥0 balances an importance of the sparse regularization loss, which is usually predetermined. The sparse regularization loss aims at promoting a number of zero valued weight coefficients among the weights {Wⱼ^{e}} and {Wⱼ^{d}}. For example, each layer can be processed individually:

S({Wⱼ^{e}}{Wⱼ^{d}})=ΣⱼS(Wⱼ^{e})+ΣⱼS(Wⱼ^{d}) (3)

Each S(Wⱼ^{e})/S(Wⱼ^{d}) is the sparse loss defined over the weight tensor Wⱼ^{e}/Wⱼ^{d}. For example, a (c₁, k₁, k₂, k₃, c₂)-size weight tensor can be flattened into a vector of size c₁×k₁×k₂×k₃×c₂, and an L₀, L₁, L₂, or L_{2,1} norm of the flattened vector can be computed as the sparse loss.

The weight pruning process includes two modules. First, in a pruning module, using the updated weights {\tilde{W}ⱼ^{e}(λᵢ)} and {\tilde{W}ⱼ^{d}(λᵢ)} as inputs, for unfixed weight coefficients among the updated weights {\tilde{W}ⱼ^{e}(λᵢ)} and {\tilde{W}ⱼ^{d}(λᵢ)}, the pruning component 485 first selects weight coefficients that are unimportant (i.e., with a small loss if pruned). Then, the pruning component 485 fixes previously-fixed weights by the masks {Mᵢⱼ^{e}}, {Mᵢⱼ^{d}}, and the weight updating component 490 updates remaining weights among the updated weights {\tilde{W}ⱼ^{e}(λᵢ)} and {\tilde{W}ⱼ^{d}(λᵢ)} by normal backpropagation to optimize the total loss of Equation (2) targeting the hyperparameter λᵢ₊₁. Multiple epoch iterations will be taken to optimize the total loss, e.g., until reaching a maximum iteration number or until the loss converges. The pruning component 485 finally outputs a set of binary pruning masks {Pᵢⱼ^{e}} and where an entry in a mask Pᵢⱼ^{e} or Pᵢⱼ^{d} being 0 means a corresponding weight in Wⱼ^{e} or Wⱼ^{d} is set to zero (pruned).

Then, the weight updating component 490 fixes additional unfixed weights among the updated weights {\tilde{W}ⱼ^{e}(λᵢ)} and {\tilde{W}ⱼ^{d}(λᵢ)} that are masked by the masks {Pᵢⱼ^{e}} and {Pᵢⱼ^{d}}, and updates remaining weights among the updated weights {\tilde{W}ⱼ^{e}(λᵢ)} and {\tilde{W}ⱼ^{d}(λᵢ)} that are not masked by either the masks {Pᵢⱼ^{e}}, {Pᵢⱼ^{d}} or {Mᵢⱼ^{e}}, {Mᵢⱼ^{d}}, by regular backpropagation to optimize the overall R-D loss of Equation (1) targeting the hyperparameter λᵢ₊₁. Multiple epoch iterations will be taken to optimize the R-D loss in this weight update process, e.g., until reaching a maximum iteration number or until the loss converges. Then, the weight updating component 490 computes corresponding masks {Mᵢ₊₁ⱼ^{e}} and {Mᵢ₊₁ⱼ^{d}} as: Mᵢ₊₁ⱼ^{e}=Mᵢⱼ^{e}∪Pᵢⱼ^{e} and Mᵢ₊₁ⱼ^{d}=Mᵢⱼ^{d}∪Pᵢᵢ^{d}. That is, non-pruned entries in the mask Pᵢⱼ^{e} (Pᵢⱼ^{d}) that are non-masked in the mask Mᵢⱼ^{e} (Mᵢⱼ^{d}) will be additionally set to 1 as being masked in the mask Mᵢ₊₁ⱼ^{e}(Mᵢ₊₁^{d}). Also, the weight updating component 490 outputs updated weights {Wⱼ^{e}(λᵢ₊₁)} and {Wⱼ^{d}(λᵢ₊₁)}. Final updated weights {Wⱼ^{e}(λ_{N})} and {Wⱼ^{d}(λ_{N})} are the final output weights {Wⱼ^{e}} and {Wⱼ^{d}} for the learned model instance.

Different patterns for binary masks can be enforced. For example, a binary mask can be structurally or unstructurally sparse. That is, zero entries can be distributed randomly or form some special pattern in a weight tensor. All layers in the DNN model may be required to have the same sparsity pattern. Each layer of the DNN model can also take a different sparsity pattern. The following gives three embodiments of the sparsity patterns.

Unstructured Masks

A binary mask can have randomly distributed zero entries. This is called an unstructured mask. In such a case, unimportant weights are weights with very small values. For example, p % weight coefficients in a weight tensor with smallest values may be chosen to be pruned.

Structured Masks

For a 5D weight tensor of size (c₁, k₁, k₂, k₃, c₂), if the weight tensor is reshaped into a 3D cube of a shape (c₁, c₂, k₁×k₂×k₃), an entire column (along c₁ axis), a row (along c₂ axis), and a channel (along k₁×k₂×k₃ axis) may be set to be zero. For example, a loss (e.g., L₁ or L₂ norm) of each column, row, or channel may be computed, and a bottom p % of columns, rows, or channels with smallest loss may be selected to be pruned.

Micro-Structured Masks

A 5D weight tensor of size (c₁, k₁, k₂, k₃, c₂) may be reshaped into a 4D tensor, a 3D cube, a 2D matrix, or even a 1D vector. Instead of setting entire rows, columns, or channels along any reshaped axis to be zero, small micro-structured weights may be set to be zero, such as small 4D, 3D, 2D or 1D blocks. For example, a loss (e.g., L₁ or L₂ norm) of each micro-structure may be computed, and a bottom p % of micro-structures may be selected to be pruned.

Comparing the above three embodiments, the unstructured masks may have a least constraint on weight coefficients and can better preserve a compression performance. However, due to randomly distributed zero entries, this embodiment may not accelerate an inference computation. The structured masks can naturally reduce computation, but with a strong constraint on weight coefficients, and therefore, the structured masks hurt compression performance more. The micro-structured masks are a trade-off between the unstructured and structured masks, and a balance between preserving a compression performance and an inference acceleration depends on a specific design of micro-structures and a corresponding hardware computing device.

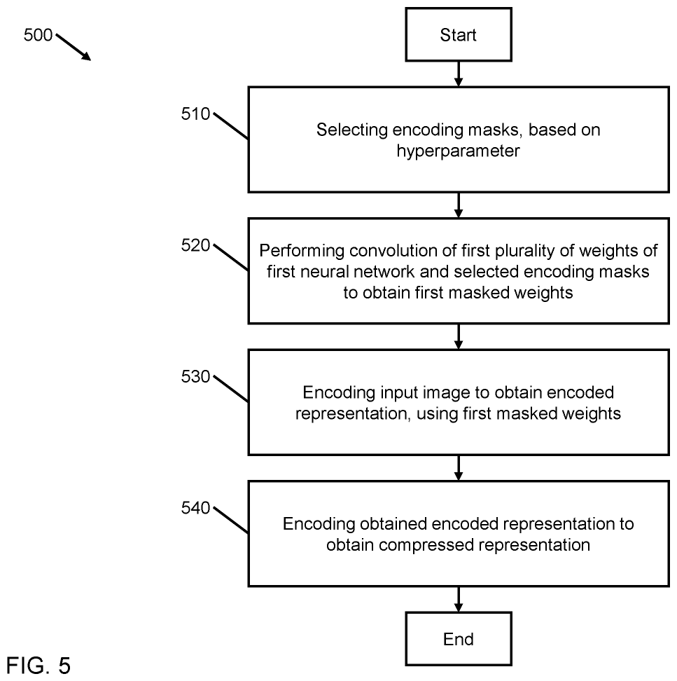

FIG. 5 is a flowchart of a method 500 of multi-rate neural image compression, according to embodiments.

In some implementations, one or more process blocks of FIG. 5 may be performed by the platform 120. In some implementations, one or more process blocks of FIG. 5 may be performed by another device or a group of devices separate from or including the platform 120, such as the user device 110.

As shown in FIG. 5, in operation 510, the method 500 includes selecting encoding masks, based on a hyperparameter.

In operation 520, the method 500 includes performing a convolution of a first plurality of weights of a first neural network and the selected encoding masks to obtain first masked weights.

In operation 530, the method 500 includes encoding an input image to obtain an encoded representation, using the first masked weights.

In operation 540, the method 500 includes encoding the obtained encoded representation to obtain a compressed representation.

Although FIG. 5 shows example blocks of the method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel.

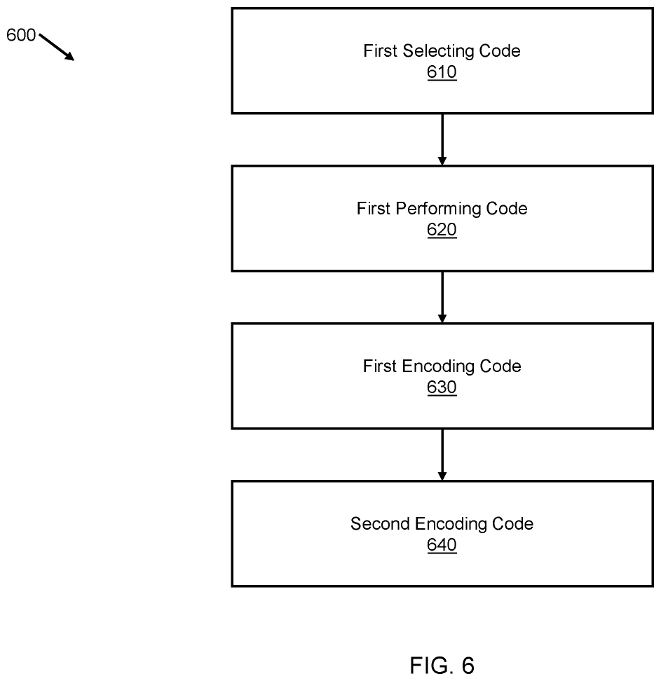

FIG. 6 is a block diagram of an apparatus 600 for multi-rate neural image compression, according to embodiments.

As shown in FIG. 6, the apparatus 600 includes first selecting code 610, first performing code 620, first encoding code 630 and second encoding code 640.

The first selecting code 610 is configured to cause at least one processor to select encoding masks, based on a hyperparameter.

The first performing code 620 is configured to cause the at least one processor to perform a convolution of a first plurality of weights of a first neural network and the selected encoding masks to obtain first masked weights.

The first encoding code 630 is configured to cause the at least one processor to encode an input image to obtain an encoded representation, using the first masked weights.

The second encoding code 640 is configured to cause the at least one processor to encode the obtained encoded representation to obtain a compressed representation.

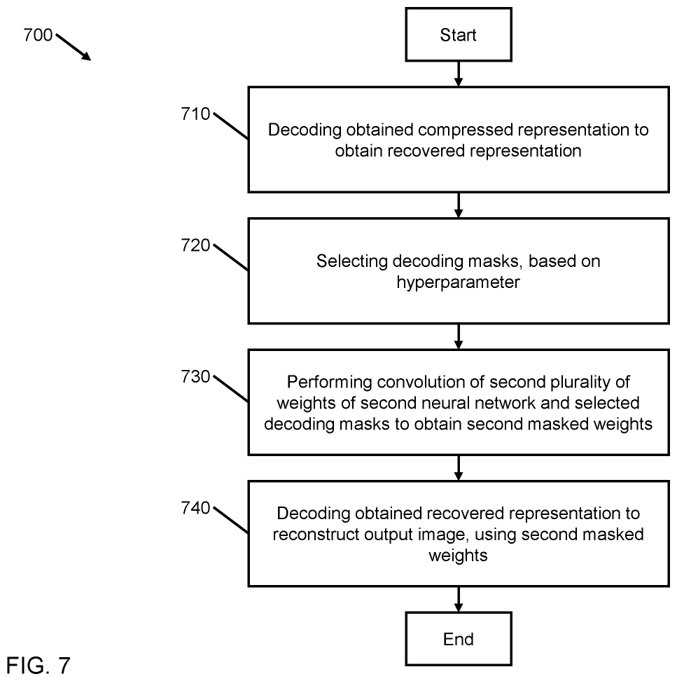

FIG. 7 is a flowchart of a method 700 of multi-rate neural image decompression, according to embodiments.

In some implementations, one or more process blocks of FIG. 7 may be performed by the platform 120. In some implementations, one or more process blocks of FIG. 7 may be performed by another device or a group of devices separate from or including the platform 120, such as the user device 110.

As shown in FIG. 7, in operation 710, the method 700 includes decoding the obtained compressed representation to obtain a recovered representation.

In operation 720, the method 700 includes selecting decoding masks, based on the hyperparameter.

In operation 730, the method 700 includes performing a convolution of a second plurality of weights of a second neural network and the selected decoding masks to obtain second masked weights.

In operation 740, the method 700 includes decoding the obtained recovered representation to reconstruct an output image, using the second masked weights.

Each of the encoding masks and the decoding masks may be partitioned into blocks, and each item in a respective one of the blocks may have a same binary value.

The first neural network and the second neural network may be trained by updating one or more of the first plurality of weights and the second plurality of weights that are not respectively masked by the encoding masks and the decoding masks, to minimize a rate-distortion loss that is determined based on the input image, the output image and the compressed representation, pruning the updated one or more of the first plurality of weights and the second plurality of weights not respectively masked by the encoding masks and the decoding masks, to obtain binary pruning masks indicating which of the first plurality of weights and the second plurality of weights are pruned, updating at least one of the first plurality of weights and the second plurality of weights that are not respectively masked by the encoding masks, the decoding masks and the obtained binary pruning masks, to minimize the rate-distortion loss, and updating the encoding masks and the decoding masks, based on the obtained binary pruning masks.

The pruning may include determining a pruning loss for each of the blocks into which each of the encoding masks and the decoding masks is partitioned, ranking the blocks in an ascending order, based on the determined pruning loss for each of the blocks, and setting two or more of the first plurality of weights and the second plurality of weights that corresponds to a plurality of the blocks that is top down among the ranked blocks until a stop criterion is reached.

Each of the encoding masks and the decoding masks may have a randomly distributed binary value.

Each of the encoding masks and the decoding masks may be partitioned into columns, rows or channels, and each item in a respective one of the columns, rows or channels may have a same binary value.

Although FIG. 7 shows example blocks of the method 700, in some implementations, the method 700 may include additional blocks, fewer blocks, different blocks, or differently arranged blocks than those depicted in FIG. 7. Additionally, or alternatively, two or more of the blocks of the method 700 may be performed in parallel.

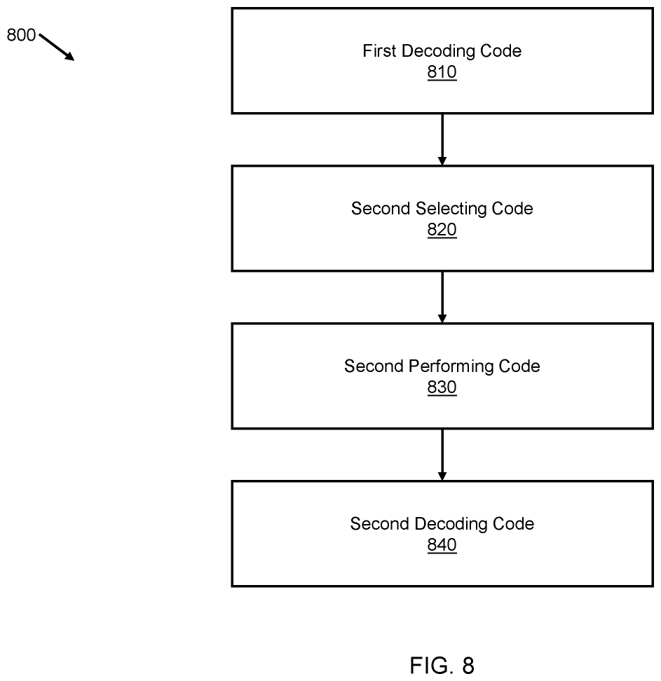

FIG. 8 is a block diagram of an apparatus 800 for multi-rate neural image decompression, according to embodiments.

As shown in FIG. 8, the apparatus 800 includes first decoding code 810, second selecting code 820, second performing code 830 and second decoding code 840.

The first decoding code 810 is configured to cause the at least one processor to decode the obtained compressed representation to obtain a recovered representation.

The second selecting code 820 is configured to cause the at least one processor to select decoding masks, based on the hyperparameter.

The second performing code 830 is configured to cause the at least one processor to perform a convolution of a second plurality of weights of a second neural network and the selected decoding masks to obtain second masked weights.

The second decoding code 840 is configured to cause the at least one processor to decode the obtained recovered representation to reconstruct an output image, using the second masked weights.

Each of the encoding masks and the decoding masks may be partitioned into blocks, and each item in a respective one of the blocks may have a same binary value.

The first neural network and the second neural network may be trained by updating one or more of the first plurality of weights and the second plurality of weights that are not respectively masked by the encoding masks and the decoding masks, to minimize a rate-distortion loss that is determined based on the input image, the output image and the compressed representation, pruning the updated one or more of the first plurality of weights and the second plurality of weights not respectively masked by the encoding masks and the decoding masks, to obtain binary pruning masks indicating which of the first plurality of weights and the second plurality of weights are pruned, updating at least one of the first plurality of weights and the second plurality of weights that are not respectively masked by the encoding masks, the decoding masks and the obtained binary pruning masks, to minimize the rate-distortion loss, and updating the encoding masks and the decoding masks, based on the obtained binary pruning masks.

The pruning may include determining a pruning loss for each of the blocks into which each of the encoding masks and the decoding masks is partitioned, ranking the blocks in an ascending order, based on the determined pruning loss for each of the blocks, and setting two or more of the first plurality of weights and the second plurality of weights that corresponds to a plurality of the blocks that is top down among the ranked blocks until a stop criterion is reached.

Each of the encoding masks and the decoding masks may have a randomly distributed binary value.

Each of the encoding masks and the decoding masks may be partitioned into columns, rows or channels, and each item in a respective one of the columns, rows or channels may have a same binary value.

Comparing with previous end-to-end (E2E) image compression methods, the embodiments described herein use only one model instance to achieve multi-rate compression effect with multiple binary masks. Two training frameworks may be used to learn the model instance and masks, which may have a block-wise micro-structure. Further, a prune-and-grow training framework may be to learn the model instance and general and flexible binary masks.

Comparing with the previous E2E image compression methods, the embodiments described herein may largely reduce deployment storage to achieve multi-rate compression, and use a flexible and general framework that accommodates various types of NIC models. The structured and micro-structured masks provide an additional benefit of computation reduction.

The proposed methods may be used separately or combined in any order. Further, each of the methods (or embodiments), encoder, and decoder may be implemented by processing circuitry (e.g., one or more processors or one or more integrated circuits). In one example, the one or more processors execute a program that is stored in a non-transitory computer-readable medium.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein may be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method of multi-rate neural image compression, the method being performed by at least one processor, and the method comprising:
selecting encoding masks, based on a hyperparameter;
performing a convolution of a first plurality of weights of a first neural network and the selected encoding masks to obtain first masked weights;
encoding an input image to obtain an encoded representation, using the first masked weights; and
encoding the obtained encoded representation to obtain a compressed representation.

2. The method of claim 1, further comprising:
decoding the obtained compressed representation to obtain a recovered representation;
selecting decoding masks, based on the hyperparameter;
performing a convolution of a second plurality of weights of a second neural network and the selected decoding masks to obtain second masked weights; and
decoding the obtained recovered representation to reconstruct an output image, using the second masked weights.

3. The method of claim 2, wherein each of the encoding masks and the decoding masks is partitioned into blocks, and
each item in a respective one of the blocks has a same binary value.

4. The method of claim 3, wherein the first neural network and the second neural network are trained by:
updating one or more of the first plurality of weights and the second plurality of weights that are not respectively masked by the encoding masks and the decoding masks, to minimize a rate-distortion loss that is determined based on the input image, the output image and the compressed representation;
pruning the updated one or more of the first plurality of weights and the second plurality of weights not respectively masked by the encoding masks and the decoding masks, to obtain binary pruning masks indicating which of the first plurality of weights and the second plurality of weights are pruned;
updating at least one of the first plurality of weights and the second plurality of weights that are not respectively masked by the encoding masks, the decoding masks and the obtained binary pruning masks, to minimize the rate-distortion loss; and
updating the encoding masks and the decoding masks, based on the obtained binary pruning masks.

5. The method of claim 4, wherein the pruning comprises:
determining a pruning loss for each of the blocks into which each of the encoding masks and the decoding masks is partitioned;
ranking the blocks in an ascending order, based on the determined pruning loss for each of the blocks; and
setting two or more of the first plurality of weights and the second plurality of weights that corresponds to a plurality of the blocks that is top down among the ranked blocks until a stop criterion is reached.

6. The method of claim 2, wherein each of the encoding masks and the decoding masks has a randomly distributed binary value.

7. The method of claim 2, wherein each of the encoding masks and the decoding masks is partitioned into columns, rows or channels, and
each item in a respective one of the columns, rows or channels has a same binary value.

8. An apparatus for multi-rate neural image compression, the apparatus comprising:
at least one memory configured to store program code; and
at least one processor configured to read the program code and operate as instructed by the program code, the program code comprising:
first selecting code configured to cause the at least one processor to select encoding masks, based on a hyperparameter;
first performing code configured to cause the at least one processor to perform a convolution of a first plurality of weights of a first neural network and the selected encoding masks to obtain first masked weights;
first encoding code configured to cause the at least one processor to encode an input image to obtain an encoded representation, using the first masked weights; and
second encoding code configured to cause the at least one processor to encode the obtained encoded representation to obtain a compressed representation.

9. The apparatus of claim 8, wherein the program code further comprises:
first decoding code configured to cause the at least one processor to decode the obtained compressed representation to obtain a recovered representation;
second selecting code configured to cause the at least one processor to select decoding masks, based on the hyperparameter;
second performing code configured to cause the at least one processor to perform a convolution of a second plurality of weights of a second neural network and the selected decoding masks to obtain second masked weights; and
second decoding code configured to cause the at least one processor to decode the obtained recovered representation to reconstruct an output image, using the second masked weights.

10. The apparatus of claim 9, wherein each of the encoding masks and the decoding masks is partitioned into blocks, and
each item in a respective one of the blocks has a same binary value.

11. The apparatus of claim 10, wherein the first neural network and the second neural network are trained by:
updating one or more of the first plurality of weights and the second plurality of weights that are not respectively masked by the encoding masks and the decoding masks, to minimize a rate-distortion loss that is determined based on the input image, the output image and the compressed representation;
pruning the updated one or more of the first plurality of weights and the second plurality of weights not respectively masked by the encoding masks and the decoding masks, to obtain binary pruning masks indicating which of the first plurality of weights and the second plurality of weights are pruned;
updating at least one of the first plurality of weights and the second plurality of weights that are not respectively masked by the encoding masks, the decoding masks and the obtained binary pruning masks, to minimize the rate-distortion loss; and
updating the encoding masks and the decoding masks, based on the obtained binary pruning masks.

12. The apparatus of claim 11, wherein the pruning comprises:
determining a pruning loss for each of the blocks into which each of the encoding masks and the decoding masks is partitioned;
ranking the blocks in an ascending order, based on the determined pruning loss for each of the blocks; and
setting two or more of the first plurality of weights and the second plurality of weights that corresponds to a plurality of the blocks that is top down among the ranked blocks until a stop criterion is reached.

13. The apparatus of claim 9, wherein each of the encoding masks and the decoding masks has a randomly distributed binary value.

14. The apparatus of claim 9, wherein each of the encoding masks and the decoding masks is partitioned into columns, rows or channels, and
each item in a respective one of the columns, rows or channels has a same binary value.

15. A non-transitory computer-readable medium storing instructions that, when executed by at least one processor for multi-rate neural image compression, cause the at least one processor to:
select encoding masks, based on a hyperparameter;
perform a convolution of a first plurality of weights of a first neural network and the selected encoding masks to obtain first masked weights;
encode an input image to obtain an encoded representation, using the first masked weights; and
encode the obtained encoded representation to obtain a compressed representation.

16. The non-transitory computer-readable medium of claim 15, wherein the instructions, when executed by the at least one processor, further cause the at least one processor to:
decode the obtained compressed representation to obtain a recovered representation;
select decoding masks, based on the hyperparameter;
perform a convolution of a second plurality of weights of a second neural network and the selected decoding masks to obtain second masked weights; and
decode the obtained recovered representation to reconstruct an output image, using the second masked weights.

17. The non-transitory computer-readable medium of claim 16, wherein each of the encoding masks and the decoding masks is partitioned into blocks, and
each item in a respective one of the blocks has a same binary value.

18. The non-transitory computer-readable medium of claim 17, wherein the first neural network and the second neural network are trained by:
updating one or more of the first plurality of weights and the second plurality of weights that are not respectively masked by the encoding masks and the decoding masks, to minimize a rate-distortion loss that is determined based on the input image, the output image and the compressed representation;
pruning the updated one or more of the first plurality of weights and the second plurality of weights not respectively masked by the encoding masks and the decoding masks, to obtain binary pruning masks indicating which of the first plurality of weights and the second plurality of weights are pruned;
updating at least one of the first plurality of weights and the second plurality of weights that are not respectively masked by the encoding masks, the decoding masks and the obtained binary pruning masks, to minimize the rate-distortion loss; and
updating the encoding masks and the decoding masks, based on the obtained binary pruning masks.

19. The non-transitory computer-readable medium of claim 18, wherein the pruning comprises:
determining a pruning loss for each of the blocks into which each of the encoding masks and the decoding masks is partitioned;
ranking the blocks in an ascending order, based on the determined pruning loss for each of the blocks; and
setting two or more of the first plurality of weights and the second plurality of weights that corresponds to a plurality of the blocks that is top down among the ranked blocks until a stop criterion is reached.

20. The non-transitory computer-readable medium of claim 16, wherein each of the encoding masks and the decoding masks is partitioned into columns, rows or channels, and
each item in a respective one of the columns, rows or channels has a same binary value.
